(19) United States
(12) Patent Application Publication
(10) Pub. No.: US 2004/0168978 A1
(43) Pub. Date: Sep. 2, 2004

(54) Method and apparatus for recirculating tangential separation system

(76) Inventor: Buddy Don Gray, Dellrose, TN (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/474,995

(22) PCT Filed: Feb. 27, 2002
(86) PCT No.: PCT/US02/22523

Related U.S. Application Data
(60) Provisional application No. 60/284,744, filed on Apr. 18, 2001.

(51) Int. Cl. B01D 65/02

(52) U.S. Cl. 210/636; 210/650; 210/652; 210/321.69; 210/195.2; 210/96.2

(57) ABSTRACT

A method of separating a mixture into a plurality of more concentrated products utilizing recirculation and concentration of one product so as to extract a substantially large fraction of another product from the mixture; and the apparatus utilizing the present method in a system, such as a reverse osmosis system, capable of very high recovery rates, efficient power usage, and long component life. Substantially 100% of the concentrate product exiting a tangential separation device, such as a reverse osmosis filtering device, recirculates until the concentration of the concentrate reaches a predetermined level, at which time the concentrate is purged from the system and a new cycle begins. This achieves recovery rates in RO-based water purification systems from around 70% for feed water with 1,000 ppm of total dissolved solids to around 97% for feed water with 100 ppm of total dissolved solids. The method and apparatus also provide for automated cleaning and maintenance of the separation and filtration elements, thus optimizing the life of the components.

### BACKGROUND OF THE INVENTION

1. Field of the Invention

The present invention relates generally to a method of separating a mixture into a plurality of components, and, more specifically, to a reverse osmosis system with substantially total concentrate recirculation, wherein the concentrate is periodically purged from the system.

2. Description of the Related Art

The use of reverse osmosis (RO) for treatment of water is well known and documented in numerous textbooks. Standard RO, without any recirculation of concentrate (waste) can provide high quality water but is normally inefficient in its utilization of power, feed water, and membrane life. Recirculating RO systems are more efficient in their use of feed water but are not normally without their problems. It is the systems of the recirculating type that will be further addressed.

Of the recirculating type of RO systems, there are those of the intermittent flow in open loop type (FIG. 1); intermittent flow in closed loop type (FIG. 2); semi-continuous flow in closed loop type (FIG. 3); and continuous flow type (FIG. 4); and the two pump total concentrate recirculation type (FIG. 5).

The operation of the intermittent flow open loop type (FIG. 1) is as follows:

A feed tank 44 starts by being full of fresh, raw water. A force feed pump 13 pumps the feed water to an RO inlet 14 on an RO element 15. A fraction (10 to 15%) of the volume pumped by the force feed pump 13 permeates an RO membrane 16 while the remainder (the concentrate) exits the element through an RO concentrate exit 17. A control valve 43 sets the pressure across the membrane sending the concentrate water back to the feed tank 44 where it mixes with the water already in the tank. This cycle continues until the contaminants in water in the feed tank increases to the point to where the system is no longer efficient, at which time the system is stopped, the feed tank is drained, and refilled with fresh raw water.

The operation of the intermittent flow closed loop type (FIG. 2) is as follows:

The feed tank 44 starts by being full of fresh, raw water. The force feed pump 13 pumps the feed water to the inlet of a recirculation pump 21, which in turn sends the water to the RO inlet 14 on the RO element 15. A fraction (10 to 15%) of the volume pumped by the recirculation pump 21 permeates the membrane 16 while the remainder (the concentrate) exits the element through the concentrate exit 17. The recirculation pump 21 mixes the concentrate with the feed water being pumped by the force feed pump 13, sending a fraction of the mixed water back to the feed tank 44 through a control valve 43, which sets the pressure across the membrane, with the remainder flowing to the RO inlet 14. This cycle continues until the contaminants in water in the feed tank increases to the point to where the system is no longer efficient, at which time the system is stopped, the feed tank is drained, and refilled with fresh raw water.

The operation of the semi-continuous flow in closed loop type (FIG. 3) is as follows:

The feed tank 44 starts by being full of fresh, raw water. The force feed pump 13 pumps the feed water to the inlet of the recirculation pump 21, which in turn sends the water to the RO inlet 14 on the RO element 15. A fraction (10 to 15%) of the volume pumped by the recirculation pump 21 permeates the membrane 16 while the remainder (the concentrate) exits the element through the concentrate exit 17. The recirculation pump 21 receives a fraction of the concentrate and mixes the concentrate with the feed water being pumped by the force feed pump 13. The remaining fraction of concentrate is sent back through the control valve 43, which sets the pressure across the membrane, to the feed tank 44, which is receiving a volume of fresh water, from the raw water inlet 11 and which is equal to the volume of permeate. This cycle continues until the contaminants in water in the feed tank increases to the point to where the system is no longer efficient, at which time the system is stopped, the feed tank is drained, and refilled with fresh raw water.

The operation of the continuous flow type (FIG. 4) is as follows:

Fresh raw water is supplied from the raw water inlet 11 to the force feed pump 13. The force feed pump 13 pumps the feed water to the inlet of the recirculation pump 21, which in turn sends the water to the RO inlet 14 on the RO element 15. A fraction (10 to 15%) of the volume pumped by the recirculation pump 21 permeates the membrane 16 while the remainder (the concentrate) exits the element through the concentrate exit 17. The recirculation pump 21 mixes the concentrate with the feed water being pumped by the force feed pump 13, continuously sending a fraction of the mixed water to drain through the control valve 43, which sets the pressure across the membrane, with the remainder flowing to the RO inlet 14. This cycle continues with the level of contaminants in the recirculation loop reaching a high level and thus limiting the amount of water able to permeate the membrane.

The operation of the two-pump total concentrate recirculation type (FIG. 5) is as follows:

Fresh raw water is supplied from the raw water inlet 11 to the force feed pump 13. The force feed pump 13 pumps the feed water to the RO inlet 14 on the RO element 15. A fraction (10 to 15%) of the total volume pumped by the force feed pump 13 and the recirculation pump 21, and which equals the volume pumped by the force feed pump 13, permeates the membrane 16 while the remainder (the concentrate) exits the element through the concentrate exit 17. The concentrate at this point is at approximately 200 psi, in a normal RO type system operating on fresh water. Next the concentrate water passes through a concentrate conductivity level detector 28, which determines when the maximum allowable concentrate level is reached. The concentrate then flows into a recirculation filter 26 where contaminants of sufficient size are filtered from the recirculating stream. The concentrate then flows into the recirculation pump 21, which establishes the velocity at which the recirculating concentrate flows. From the pump 21 the concentrate mixes with the incoming raw feed water, which is pumped at a constant flow established by the pump 13 and at a rate that is equivalent to that which permeates the membrane 16, and exits a reverse osmosis permeate exit 18. A raw water check valve 23 prevents the recirculating high pressure concentrate from back feeding into the raw water inlet 11. As the concentrate and raw water mixture flows through the system, the level of concentrate increases with each trip through the system. When the concentrate, sensed by a level detector 28, reaches a predetermined level, a purge dump solenoid valve 30 opens and purges the system of concentrate. During the purge, the recirculation water check valve 24 prevents raw water from back-flowing through the filter 26, while allowing raw water to flow a high velocity through the pump 21, into the inlet 14, and out the exit 17. This effectively purges the system of concentrate. After predetermined conditions are met, the valve 30 closes and the cycle starts anew.

There have been numerous attempts to improve the efficiency of these types of RO systems. These include:

U.S. Pat. No. 3,959,146 (Bray), while not actually of the recirculating type of RO system, attempts to increase membrane life and overall system efficiency by flushing the membrane with feed water. While this would increase the efficiency somewhat, the flushing is directly tied to the withdrawal of product water from a storage tank and not to the present condition of the system or the feed water quality.

U.S. Pat. No. 4,498,982 (Skinner), which is of the continuous flow type system depicted in FIG. 4, recirculates a portion of the concentrate through the system during normal operation. Skinner's system is modified however, in that purified water is recirculated through the system when no water is being withdrawn. While this would aid in keeping non-purified water, and its contaminants, off of the membrane, the excess power requirements would quickly outweigh the benefits.

U.S. Pat. No. 4,626,346 (Hall), which is of the intermittent flow in open loop type depicted in FIG. 1, and U.S. Pat. No. 5,282,972 (Hanna et al.), and U.S. Pat. No. 5,520,816 (Kuepper), which are of the semi-continuous flow in closed loop type as depicted in FIG. 3, recirculate the concentrate (waste) stream from the RO system back to either a limited volume feed water tank or directly to feed lines that serve to feed either the RO system or non-potable water applications such as toilets, dish washing, showering, and bathing. While this would aid in conserving feed water in general, it provides the non-potable water applications with increasingly contaminated water. While earlier it was thought that the afore-mentioned non-potable water applications posed no threat from the use of contaminated water, it is now well known that many harmful affects can result from absorption of contaminants through the skin and through inhalation of water vapors.

U.S. Pat. No. 5,503,735 (Vinas et al), which is of the continuous flow type depicted in FIG. 4, recirculates a portion of the concentrate stream back through the RO system. While this does utilize more of the feed water, the recirculation is only a portion of the entire concentrate stream (with the remainder going to drain). It is controlled through a pressure relief valve that is not sensitive to feed water quality. The system does have a means to flush the membrane with a combination of feed water and recirculated concentrate water. This flush is performed at predetermined intervals and is not dependent upon the condition of the system. This can result in wastage of water through premature flushing, or it can result in permanently damaged RO elements through delayed flushing. The preferred recovery rate for the system is 50%, which means that only half of the feed water is purified while the other half is sent to drain.

U.S. Pat. No. 5,597,487 (Vogel et al.), which is of the continuous flow type as depicted in FIG. 4, recirculates either all or part of the concentrate stream back through the RO system. While recirculating all of the concentrate through the system increases the efficiency of feed water utilization, the system is intended for small quantity production and dispensing into small portable containers, such as one gallon jugs. As such, and to keep the feed water from becoming over contaminated, the system flushes after each withdrawal or on a timed basis with a mixture of purified water, feed water, and concentrate. Either way, the flushing is not performed at any optimal time with respect to the quality of the water being sent to the RO element. This can result in wastage of water through premature flushing or it can result in over contaminated water being fed to the RO element.

U.S. Pat. No. 5,647,973 (Desaulniers), which is of the continuous flow type as depicted in FIG. 4, attempts to improve the feed water utilization efficiency of the system through controlling the proportion of the concentrate water being recirculated based on the quality of the water being fed to the RO element. While this allows the system to adjust somewhat to varying feed water qualities, there is always a portion of the concentrate water being sent to drain, resulting in less than optimum recovery and thus waste of feed water.

U.S. Pat. No. 5,817,231 (Souza), which is also actually of the continuous flow type as depicted in FIG. 4, is designed to recirculate somewhere from at least a portion to all of the concentrate water, but provides no means of actually purging any concentrated concentrate water from the system. Rather only the proportion of recirculation is controlled, with the non-recirculated portion going to drain. This again results in less than optimum recovery and, thus, a waste of feed water.

What these above systems all have in common is that the use of any recirculated concentrate water is not optimized in that there is no precise means to rid the system of just that portion of the recirculated water that has become concentrated to the maximum desirable concentration.

Copending P.C.T. Application entitled REVERSE OSMOSIS SYSTEM WITH CONTROLLED RECIRCULATION, filed 09 Jan. 2002 (Gray), which is of the type depicted in FIG. 5, attempts to overcome many of the deficiencies of the previously mentioned inventions, however, additional shortcomings are also inherently introduced. These shortcomings include:

The necessity of two pumps, both of which must be able to withstand the high pressure encountered with reverse osmosis type systems.

The recirculation filter must be able to withstand high pressures and could constitute a safety hazard if incorrectly operated or damaged.

The purge valve on the recirculation filter must operate at high pressures and is subject to massive leakage by conditions that would pose no problem at lower pressures.

The conductivity level detector must be able to withstand high pressures without leaking externally or weeping through the wires into the control box.

The raw water check valve must be able to function properly against the large differential pressure between the low pressure inlet feed water and the high pressure recirculating concentrate, so as to prevent cross contamination of the inlet feed water system which could contaminate raw water going to other residences or facilities.

The multitude of fittings, connectors, and tubing that must be able to withstand the high pressures without leaking.

The process or filtration aid feed pump and solenoid valve, as well as the rest of the system, which must be able to withstand and overcome the high pressures of the system in order to feed the process or filtration aid into the system.

During purge cycles, production of purified water is essentially halted, resulting in an overall decrease in system capacity.

Furthermore, as RO elements in general function to purify water by concentrating contaminants on one side of the membrane while allowing purified water to permeate the membrane, it is inevitable that the concentrated contaminants will become even more concentrated on the surface of the membrane itself. As this happens, the rate of permeation, or flux, may decrease. As well, the amount of contaminants that permeate the membrane may increase. Whether either or both of these situations occur, the performance of the system decreases. In prior systems, either nothing is done to prevent this decrease in performance, which may be acceptable in certain situations, or an antiscalant is added to the water to aid in the prevention of scale on,the membranes, or the RO elements may be physically removed from the system and cleaned using a specialized cleaning system, or most likely the elements are removed and discarded with new elements installed.

These shortcomings introduce various situations that should be taken into consideration in the overall operation, cost, and performance of an RO system. These include safety concerns, system integrity concerns, high cost items to withstand the high pressures encountered, and extensive downtime required to remove, transport, clean, and replace elements that require cleaning, the quality of the raw feed water, the overall quality of the water produced, the amount of water sent to drain, and the quantity of water produced.

Therefore, a need exists for an affordable and reliable system that will self adjust for changing feed water qualities while maintaining a highly efficient utilization of both power and feed water and while prolonging the life of the RO membranes, at the same time providing a steady useable flow of safe, purified water.

### BRIEF SUMMARY OF THE INVENTION

The disclosed embodiments of the present invention relate generally to a method of separating a mixture into a plurality of components, each one substantially and respectively purer than the original mixture and to a fluid treatment device where a mixed fluid is separated into fluid flows of a substantially pure base fluid (the permeate), and a separate fluid flow (the concentrate) where the non-base fluid and other materials contained in the fluid are more concentrated than in the original mixed fluid. In one embodiment, the method and apparatus relate to a water treatment system utilizing tangential filtration, such as reverse osmosis (RO), and the processes and devices required to ensure the effectiveness and efficiency of the overall process. In another embodiment, a “Whole House” or “Point Of Entry” type system for residential applications is provided where the treated water is supplied to all water outlets within or outside the living quarters. Ideally, the contaminants are physically removed from the product water stream rather than converting them to some other form through oxidation, chemical addition, or ion exchange.

In accordance with another aspect of the present invention, a reverse osmosis system with substantially total concentrate recirculation is provided, wherein the concentrate is periodically purged from the system, and wherein the purge is initiated by automatic control using electrical or mechanical monitoring of the concentrate concentration to initiate the purge cycle.

In accordance with a further embodiment of the present invention, a system is provided that self adjusts the period between purge cycles dependent upon the raw water quality presently being fed to the system, thus making the system suitable for universal distribution without being specifically tailored for the water quality at the installed site.

In accordance with another yet a further aspect of the present invention, a water treatment system suitable for industrial, commercial, military, emergency, and medical applications as well as residential and recreational applications is provided.

As will be readily appreciated from the foregoing, the disclosed embodiments of the invention provide a fully functioning system capable of providing safe “drinking water quality” water to an entire house or to other systems that could benefit from a cost effective, resource conservative, energy efficient source of high purity water with an average of 98% of the contaminants physically removed. It has the ability to function, without modification or human intervention, over a broad range of feed water qualities; to self adjust the recovery percentage of the feed water so as to maintain the maximum utilization of the feed water based upon the feed water quality; to maintain a high level of contaminant rejection without compromising product water quality; and to produce high quality water with high recovery rates while keeping energy usage to a minimum.

The embodiments of the invention also provide the ability to preserve the integrity and performance of the RO elements and their membranes; the ability to perform all of the above while keeping component count and complexity to a minimum and while providing a high degree of reliability; as well as the ability to clean the RO elements in place, and to reduce the contaminate level in the recirculating concentrate stream.

The apparatus portion of this invention satisfies the need for a system that: is a fully functioning system capable of providing safe drinking water quality water to an entire house or to other systems that could benefit from a cost effective, resource conservative, energy efficient source of high purity water; will function without modification or human intervention, over a broad range of feed water qualities; has the ability to self adjust the recovery percentage of the feed water so as to maintain the maximum utilization of the feed water based upon the feed water quality; has the ability to maintain a high level of contaminant rejection without compromising product water quality; has the ability to produce high quality water with high recovery rates while keeping energy usage to a minimum; has the ability to preserve the integrity and performance of the RO elements and their membranes; has the ability to perform all of the above while keeping component count and complexity to a minimum and while providing a high degree of reliability.

### BRIEF DESCRIPTION OF THE SEVERAL VIEWS OF THE DRAWINGS

The foregoing and other features and advantages of the present invention will be more readily appreciated as the same become better understood from the following detailed description when taken in conjunction with the following drawings wherein like reference numbers identify like elements, and further wherein:

FIG. 1 depicts a known intermittent flow in open loop type RO system.

FIG. 2 depicts a known intermittent flow in closed loop type RO system.

FIG. 3 depicts a known semi-continuous flow in closed loop type RO system.

FIG. 4 depicts a known continuous flow type RO system.

FIG. 5 depicts a two-pump total concentrate recirculation type RO system.

FIG. 6 is a diagram of one embodiment of the invention.

FIG. 7 is a diagram of another embodiment of the invention with the additional processing to ensure proper operation of the RO elements and optional placement of the anti-microbial UV light.

FIG. 8 is a graph that shows the volume of water produced between purges for a range of feed water conditions.

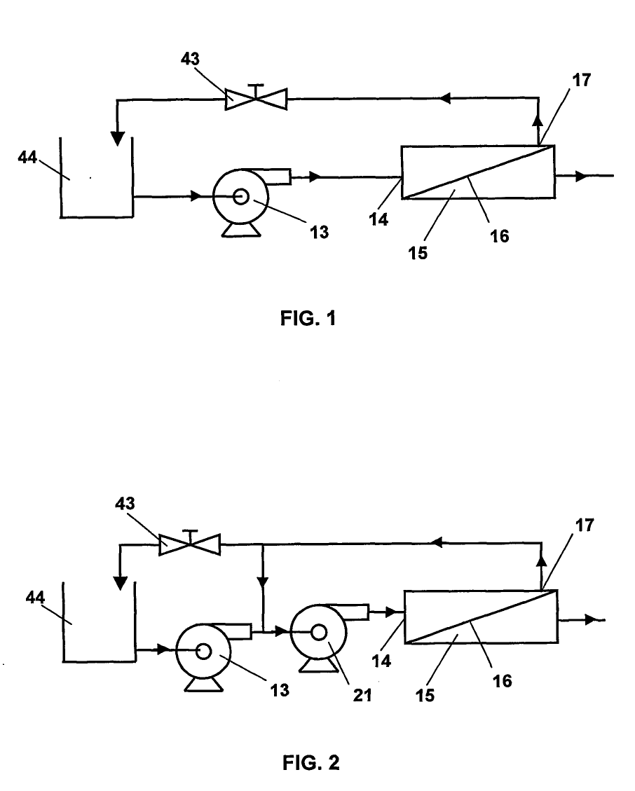

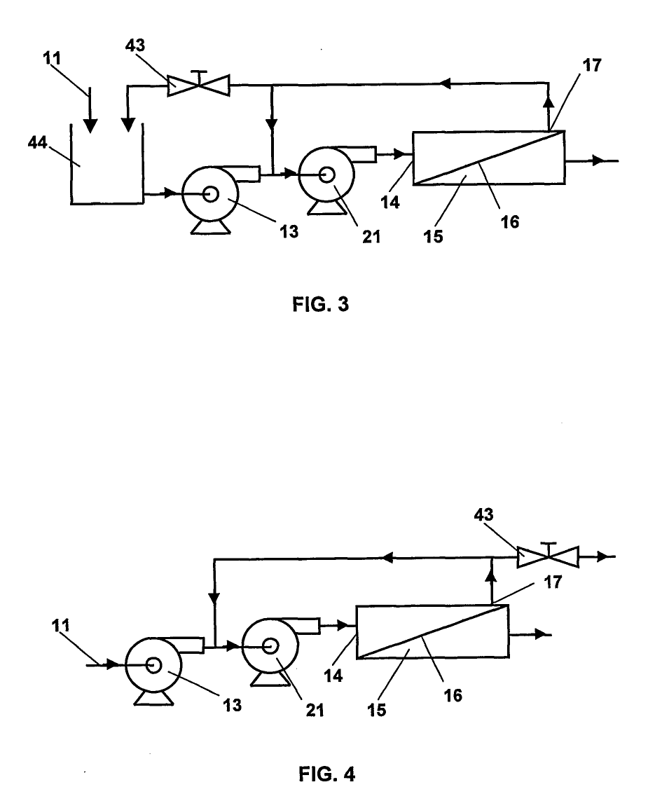

### DETAILED DESCRIPTION OF THE INVENTION

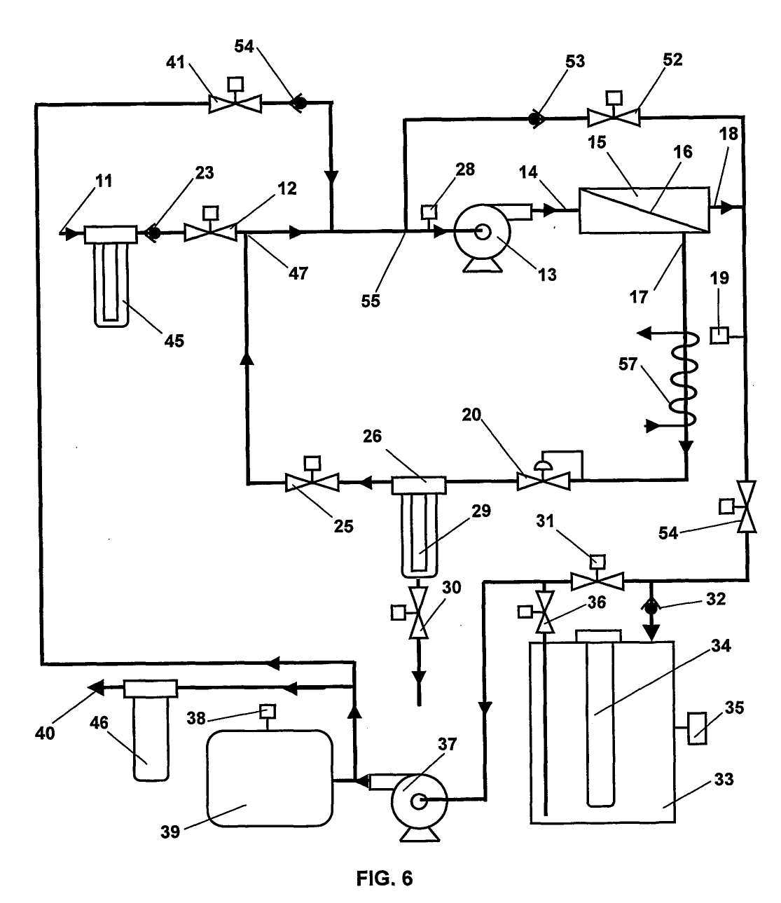

Referring to FIG. 6, there is shown an embodiment of the invention that is a fluid treatment apparatus suitable for use as a “whole house” or “point of entry” residential reverse osmosis (RO) water treatment system. The system may be suitable for supplying an entire dwelling (sinks, tub, toilets, clothes washer, dishwasher, icemaker, and all other potable as well as non-potable water sources) with water that is drinking water quality. This embodiment, as is or with obvious changes, is also suitable for use in industrial and commercial applications.

During a purification cycle, feed water, which may be sourced from a municipal water system, well, spring, or other suitable source. It is ideally delivered to the system at a flow rate that is equivalent to the rate of permeation through the RO membranes during normal processing and at a rate equivalent to the maximum flow of the system during a purge. The feed water enters the system through the feed water inlet 11, and it goes directly into the system's pre-filtration subsystem 45. In the case of this particular embodiment, the filtration subsystem 45 consists of simply a carbon block filter, but may consist of a particulate filter, granular activated carbon filter, or other combinations of commercially available filtration or treatment devices, suited for the contaminants normally found in the source water and which will provide the necessary protection from minerals, oxidants, and other harmful chemicals for the reverse osmosis elements 15, as well as lower peak concentrations of chemicals that may not be satisfactorily removed through the RO process.

Next, the pretreated feed water flows through a raw water check valve 23, and through an inlet solenoid valve 12, which closes to stop the flow of feed water into the system and opens to allow flow. During normal operation, the feed water is picked up by a force feed pump 13, which pumps a volume of feed water equal to, as a minimum, one to ten times the volume of product water expected at the RO permeate exit 18, up to a maximum allowed by the particular RO elements. From the force feed pump 13, the feed water then flows to the RO inlet 14, where within the RO element 15, the feed water is exposed to the RO membrane 16. Depending upon the pressure, temperature, and other physical and chemical properties of the feed water, somewhere normally from five to twenty percent of the water flowing into the RO element 15 will permeate the membrane 16 and exit through the reverse osmosis permeate exit 18 as purified product water with around 98% of the contaminants removed. The remaining 75% to 95% of the feed water, along with around 98% of the contaminants from the water that permeated the membrane 16, flows out of the reverse osmosis concentrate exit 17 and enters the recirculation portion of the system. The concentrate water continues to flow until it reaches a pressure regulating valve 20, which establishes the pressure generated by the pump 13 and to which the membrane 16 is exposed.

When the concentrate stream passes through the valve 20, the pressure of the concentrate stream drops to around 30% or less of the pressure generated by the pump 13. The concentrate then flows into a recirculation filter 26, which, unlike prior devices, does not have to withstand the full pressure of the RO portion of the system. The flow continues on through a recirculation filter element 29, through a recirculation stop solenoid valve 25, which is open during this portion of the cycle, and to a water combination tee 47, where the recirculating concentrate water is mixed with a volume of raw water equal to that which permeates the RO membrane 16.

From this point, the mixed raw and recirculating concentrate water flows through the concentrate conductivity level detector 28, which measures the conductivity or the total dissolved solids (TDS) of the mixed water prior to its entering into the pump 13, where the water is again pressurized, starting the cycle over again.

As an option, a heat exchanger 57 can be utilized to increase the temperature of the concentrate water, which in turn increases the temperature of the water entering the RO element 15. Most RO elements provide higher throughput on warmer water. Thus, the heat exchanger 57, by inputting heat energy into the feed fluid to the RO elements, causes an increase in performance. Furthermore, the heat energy input into the heat exchanger 57 can either be from a primary source or from waste heat from wastewater, air conditioning exhaust, ground source, or air source.

As an example, assume an initial feed water concentration equivalent to 1,000 ppm and a recirculation flow of 37.85 liters (10 gallons) per minute. As the water flows the first time through the RO element 15, 20% of the flow, or 7.57 liters (2 gallons) per minute, is forced to permeate the RO membrane 16, while 30.28 liters (8 gallons) per minute flows out through the RO concentrate exit 17. This water is now at a concentration of 1245 ppm, as can be seen by equation 1,

C_{c}=(F_{c}−(F_{c}·Pᵣ·Rₚ))/(1−Pᵣ) (1)

Where F_{c}=Fresh Water Feed Concentration in ppm

Pᵣ=Percent Recovery Fraction

Rₚ=Permeate Percentage Fraction of Contaminants

C_{c}=Concentrate Concentration in ppm

C_{c}=(1000−(1000·0.2·0.02))/(1−0.2)

C_{c}=(1000−4)/0.8

C_{c}=966/0.8

C_{c}=1245 ppm

The concentration of contaminants in the permeate water is roughly 2% of the concentration fed to the RO element 15, or 20 ppm. As the concentrate water mixes at the tee 47 with fresh feed water at the rate of 7.57 liters (2 gallons) per minute, the concentration in the recirculating feed water now becomes 1196 ppm, as can be seen by equation 2.

F_{rc}=(C_{c}·(1−Pᵣ))+(F_{c}·Pᵣ) (2)

Where: F_{c}=Fresh Water Feed Concentration in ppm

F_{rc}=Recirculating Feed Water Concentration in ppm

Pᵣ=Percent Recovery Fraction

P_{f}=Permeate Flow

C_{c}=Concentrate Concentration in ppm

F_{rc}=(1245—(1−0.2))+(1000·0.2)

F_{rc}=(1245·0.8)+(200)

F_{rc}=(996)+(200)

F_{rc}=1196 ppm

As the newly mixed recirculating feed water is presented to the RO element 15, F_{rc} replaces F_{C} in equation 1 to form equation 3

C_{c}=(F_{rc}−(F_{rc}·Pᵣ·Rₚ))/(1−Pᵣ) (3)

C_{c}=(1196−(1196·0.2−0.02))/(1−0.2)

C_{c}=(1196−4.784)/0.8

C_{c}=1191.2/0.8

C_{c}=1489 ppm

This water again mixes with the fresh feed water, and after again applying equation 2, this time using the new C_{c}, the new concentration in the recirculating feed water now becomes 1391 ppm. This loop continues until a predetermined concentration is reached, as will be described in detail later.

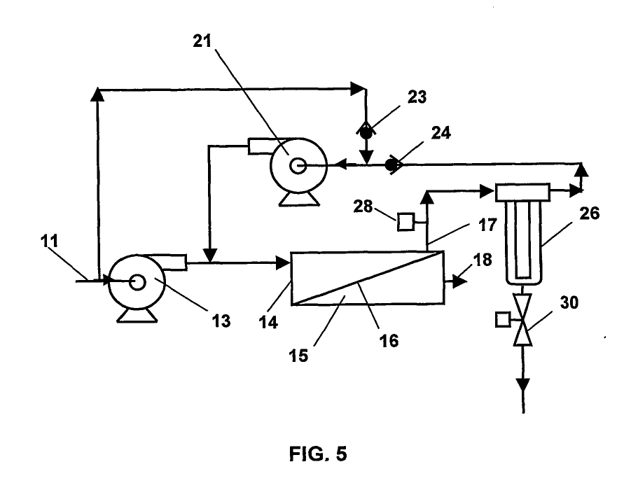

While the concentrate water is being recirculated through the recirculation portion of the system, it passes through the recirculation filter 26, and subsequently through the recirculation filter element 29. This filter has several functions. The first is to collect particles of debris, scale, or other contaminants that are large enough to become trapped in it. The second is to serve as a support for a commercially available chemical filtration aid, if used, which increases the ability of the filter to collect particles smaller than normally possible. The third is to provide a surface inductive to the precipitation of scale forming contaminants. The forth is to provide a surface that can be flushed clean of trapped contaminants through the purge dump solenoid valve 30. Unlike the filter 26 and the purge dump solenoid valve 30 of the prior device of FIG. 5, which must be able to withstand the full pressure of the RO portion of the system, in the system of the present invention, these two components, as well as several others, are exposed only to essentially the pressure of the inlet feed water at the raw water inlet 11.

During the normal recirculating mode, the recirculation water solenoid valve 25, is open, the purge dump solenoid valve 30 is closed, and the product water purge solenoid valve 41 is closed. This, in effect, creates a semi-closed loop with the force feed pump 13 drawing from the raw water inlet 11 a volume equal only to that portion of the recirculating water that permeates the RO membrane 16.

The concentrate conductivity level detector 28 is continuously monitoring the concentration of contaminants in the mixed water as it enters the pump 13. When the concentration of contaminants reaches a predetermined level (which for the purpose of example assumes a predetermined level of 2,500 ppm) the system goes into a purge mode. In this mode, the recirculation valve 25 closes, and simultaneously the purge dump solenoid valve 30 opens. The total volume of water pumped by the pump 13 is now drawn in from the raw water inlet 11 and pumped into the RO element 15. Since the system is still operating at the normal system pressures, five to twenty percent of the feed water volume still permeates the membrane 16, exiting through the permeate exit 18 as purified water. The remaining 80% to 95% of the feed water exits through the concentrate exit 17, through the valve 20, and into the filter housing 26, then out through the purge dump solenoid valve 30 to drain, effectively dislodging trapped contaminants from the element 29 and purging them from the system. Note that there is no flow, in the normal direction, through filter element 29 while in the purge mode.

The system stays in the purge mode for a predetermined length of time that would normally be equivalent to the length of time required to purge the system of the previously recirculated volume of water, preferably with the volume being kept to a minimum. When exiting the purge mode, the valve 30 closes and the valve 25 opens, establishing the normal recirculation loop. The system continues to alternate between the recirculation mode and the purge mode as long as the product storage reservoir 33 is in need of water. The water storage system will be discussed in detail later.

While, for discussion, 1000 ppm was used as the contaminant level in the raw feed water, the actual level of contaminants in feed water will vary from site to site and may even vary to a great extent at any one particular site. Rather than have the system preset for a nominal contaminant level and have the system function at less than optimum performance, and rather than have the system manually fine tuned for each installed site, the system has the inherent ability to adapt to the level of contaminants in the feed water at any given time or place. Using equations 1, 2, and 3 as the bases for a table, a graph, as depicted in FIG. 8, can be constructed. This graph shows the volume of water produced between purges for a range of feed water conditions.

As purified water flows from the RO permeate exit 18, it passes through the permeate conductivity level detector 19, which constantly monitors the conductivity of the purified water before it continues on to the reservoir 33. If the purified water exceeds a predetermined conductivity, either an alarm is sounded or is transmitted via amodem or some other telecommunications means to a central monitoring station, or the system can be shut down.

Under normal conditions, the purified water continues on through the permeate check valve 32 and enters the reservoir 33 where purified water is stored until needed to feed the product water pressure pump 37, in which case the water exits reservoir 33 through the storage reservoir outlet solenoid valve 36. While the water is stored in the reservoir 33, it is subject to airborne biological contaminants. To ensure that the microbial contaminants do not propagate, the stored water may be either continuously, or intermittently, irradiated with UV light from the anti-microbial UV light 34.

As water is pulled from the reservoir 33 by the pump 37, the level in the reservoir 33 drops. The storage reservoir level detector 35 senses the level and at a predetermined low level it initiates a purification cycle. If, during a purification cycle, the reservoir 33 drops to a low low level, as detected by the detector 35, the permeate steering solenoid valve 31 opens, the outlet solenoid valve 36 closes, the check valve 32 closes, and the purified water bypasses reservoir 33 to be fed directly into the pump 37. This aids the system by increasing the production rate by applying the negative pressure generated by the pump 37 directly to the low pressure, or permeate, side of the membrane 16. Thus increases the apparent pressure on the high-pressure, or feed water, side of the membrane 16. This also ensures that the pump 37 will always have access to water and will not be ingesting air, which would be the case if the reservoir 33 was pumped dry.

As the level in the reservoir 33 raises above the low low level, the permeate steering solenoid valve 31 closes, the outlet solenoid valve 36 opens, and the check valve 32 opens, returning flow to the normal configuration.

When a high level is detected in the reservoir 33 by the detector 35, removing power from the pump 13 halts the purification cycle. The inlet solenoid valve 12 closes as does the recirculation stop solenoid valve 25. So as to substantially reduce the process of osmosis, or the passage of contaminants from the concentrate side of membrane 16 to the purified side, the product water purge solenoid valve 41 and the purge dump solenoid valve 30 open for a predetermined length of time. This length of time is sufficient in length to allow purging of all contaminated water with purified water from the product water pressure tank 39 and through the purge solenoid valve 41, from the inlet of the pump 13 through the feed water side of the RO element 15, then through the housing of the filter 26 and out through purge dump solenoid valve 30.

As water is used, it flows out of the tank 39, into which the pump 37 has pumped purified water under pressure, through the product water carbon filter 46, and out of the product water exit 40. The product water pressure detector 38 monitors the pressure in the tank 39 and at low pressure turns the pump 37 on, and at high pressure it turns the pump 37 off. A typical low pressure is 30 PSIG, while a typical high pressure is 45 PSIG.

As the pump 37 draws water from the reservoir 33 to fill and pressurize the tank 39, the level in the reservoir 33 drops. As this level drops below the low level established by the detector 35, a new purification cycle is started. Since there is always an amount of contaminants in the concentrate side of the system, even though the concentrate water has been purged out of the system, an option would be that upon start of the cycle, the product water purge check valve 54 can be closed and the product water recirculate valve 52 can be opened for a predetermined period of time. This effectively allows any contaminants, passing through the membrane via osmosis during down time, to be effectively recycled and removed from the product water.

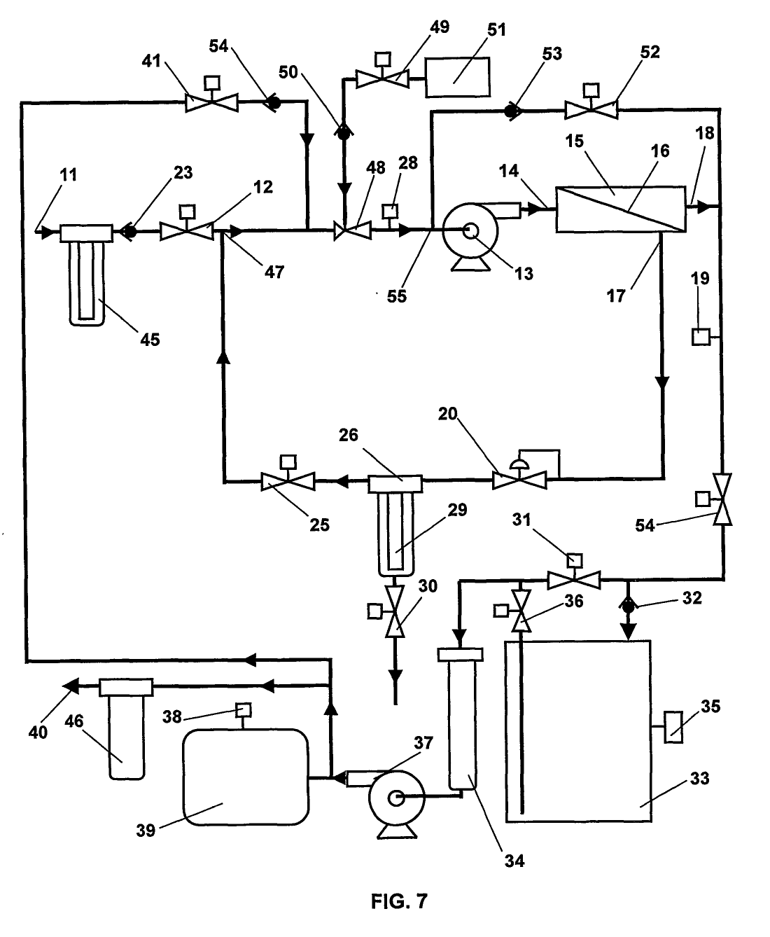

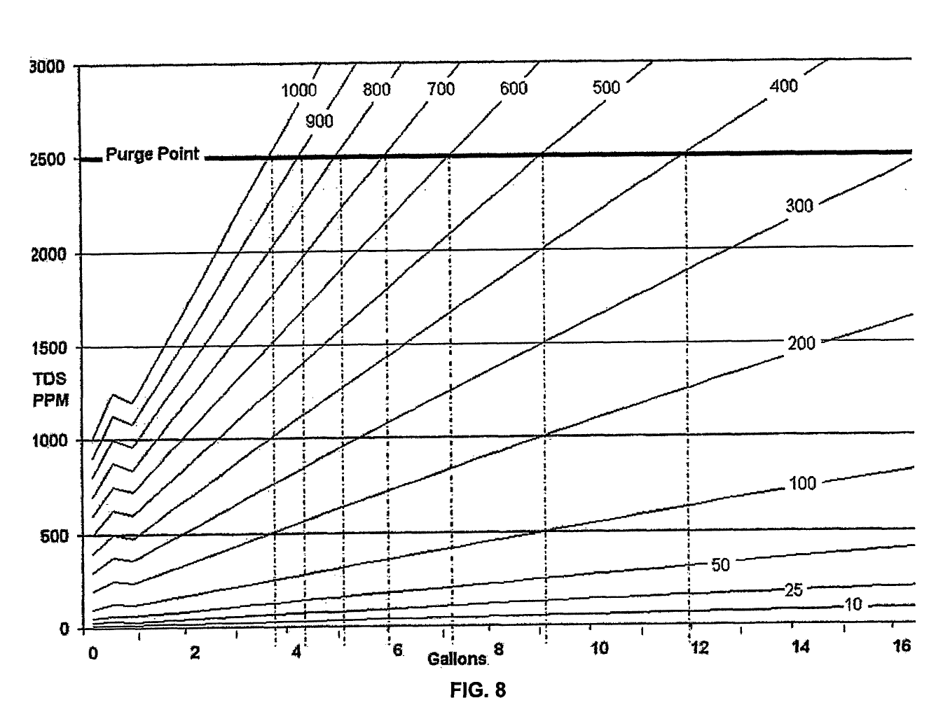

FIG. 7 depicts a further embodiment of the invention that functions exactly as that depicted in FIG. 6 and described above, with several exceptions. Firstly, there is included a method to clean in place the RO element 15. Secondly, the anti-microbial UV light 34 is located in the line between the storage reservoir 33 and the pump 37 and it comes on only when the pump 37 is on. Cleaning of the system is best performed at a predetermined time, which could coincide with the normal system purge, or which could be on a periodic bases, such as weekly, monthly, or some other fixed period of time, or which could be based upon the volume of water processed, or which could be based upon the actual performance of the system as determined by various sensors and control circuitry (not shown). Whichever method is used to determine the proper time to clean the RO element 15, the system would purge by closing the inlet solenoid valve 12 while opening the purge dump valve 30 and the product water purge solenoid valve 41, all while the pump 13 is running. After the purge period is complete, a cleaner solenoid valve 49 opens for a predetermined period of time to deliver the proper quantity of cleaner from a cleaner solution reservoir 51. The cleaner is drawn through a cleaner feed check valve 50 by a cleaner feed venturi 48, where it is mixed with the flow of water entering the pump 13. Alternatively, the cleaner could be fed by a separate pump (not shown).

Once the system is dosed with cleaner, the purge dump solenoid valve 30, product water purge solenoid valve 41, and the cleaner solenoid valve 49 close, and the inlet valve 12 remains closed. The product water purge check valve 54 closes, and the product water recirculate valve 52 opens, allowing product water to flow through the product water check valve 53 and into a product water combination tee 55, where the recirculating product water is mixed with the recirculating concentrate water. The cleaning mixture is allowed to circulate for a predetermined period, at which time the product water purge solenoid valve 41 and the purge dump solenoid valve 30 open, purging the system of cleaning solution. When the purge is complete, the system shuts down, ready for the next purification cycle to start.

In addition, and not shown, a scheme similar to that used to feed cleaner into the system can be located prior to the filter 26 and after the pressure regulating valve 20 so as to allow a filtration or process aid to be fed into the system and onto the filter element 29. This can aid in removal of a portion of the concentrate contaminants from the recirculating concentrate stream, in effect lowering the level of concentration seen by the RO element 15.

A control circuit (not shown) is provided that controls the opening and closing of the various valves, operation of the UV light, and activation and deactivation of the various pumps. The control circuit can be formed of known components by one of ordinary skill in the art to which the invention pertains and will not be described in detail herein. The operation of this control circuit will be in accordance with the foregoing description of the various embodiments of the reverse osmosis method and system.

While the principles of the invention have now been illustrated and described, it is to be understood that modifications may be made in the structure, arrangements, proportions, elements, materials and components used in the practice of the invention and otherwise, which are particularly adapted for specific environments S and operational requirements without departing from the spirit and scope of the invention. Thus, the invention is to be limited only by the scope of the claims that follow and the equivalents thereof.

What is claimed is:

1. A method of separating a feed mixture into a plurality of products in a filter system, comprising:
passing the feed mixture through a separation device to separate the feed mixture into a first product and a second product that are purer and more concentrated, respectively, than the feed mixture;
mixing the second product with the flow of the feed mixture prior to its entry into the separation device;
continuing the separating and mixing steps until the second product reaches a predetermined concentrate level;
purging the concentrated second product when the predetermined concentrate level is reached; and
repeating the separating, mixing, and purging steps.

2. The method of claim 1 comprising heating the second product prior to mixing with the feed mixture.

3. The method of claim 1 wherein the mixture of the second product and the feed mixture are heated prior to the separating step.

4. The method of claim 1 further comprising introducing a cleaner to clean the system.

5. A feed fluid treatment apparatus, comprising:
a tangential filtration device having an inlet to receive the feed fluid and configured to separate the feed fluid into a permeate fluid that is substantially free from contaminants, and a concentrate fluid wherein the contaminants removed from the feed fluid are concentrated;
a concentrate fluid circuit configured to receive the concentrate fluid exiting the tangential filtration device and to circulate the concentrate fluid back to the inlet of the tangential filtration device, and to mix the circulating concentrate fluid with the feed fluid prior to the tangential filtration device, effectively increasing the concentration of the concentrate fluid;
a monitoring device configured to monitor the concentrate fluid and initiate purging of the apparatus when the predetermined concentration of the concentrate fluid is reached;
a purge system configured to purge the apparatus of the concentrate fluid when the predetermined concentration of the concentrate fluid is reached;
an inlet configured to admit feed fluid to be added to the circulating concentrate fluid to replace the amount of permeate fluid permeating said tangential filtration device and to replenish the apparatus with fresh feed fluid as the apparatus is purged of the concentrated circulating concentrate fluid.

6. The fluid treatment apparatus of claim 5 wherein the concentrate fluid circuit further comprises a filtration device configured to trap a portion of the concentrate fluid, effectively lowering the concentration of the concentrate fluid.

7. The fluid treatment apparatus of claim 6 wherein the filtration device further comprises a purge device whereby at least a portion of the contaminants trapped by the filtration device are purged out of the apparatus to effectively extend the life and maintain the performance of the filtration device.

8. The fluid treatment apparatus of claim 6 further comprising a process device cooperating with the filtration device to cause the filtration device to trap materials that would normally pass through the filtration device.

9. The fluid treatment apparatus of claim 5, further comprising a process device configured to cause the tangential filtration device, after being in use, to substantially regain prior performance.

10. The fluid treatment apparatus of claim 5, further comprising a process device configured to remove from the feed fluid materials that are ruinous to the tangential filtration device.

11. The fluid treatment apparatus of claim 5, further comprising a process device configured to remove contaminants that permeate the tangential filtration device and pass into the permeate fluid, and which are a contaminant to said permeate fluid.

12. The fluid treatment apparatus of claim 5, further comprising a process device configured to input energy, preferably from a waste source, into the feed fluid to cause an increase in the performance of the tangential filtration device.

13. The fluid treatment apparatus of claim 5, further comprising a monitoring device configured to monitor the concentrate in the permeate fluid.

14. The fluid treatment apparatus of claim 5, further comprising a storage apparatus configured to store the permeate fluid.

15. The fluid treatment apparatus of claim 14, further comprising a controller for starting and stopping processing cycles based on the contents of said storage apparatus.

16. The fluid treatment apparatus of claim 14, further comprising a pressurization device to pressurize the permeate fluid.

17. The fluid treatment apparatus of claim 14, further comprising a disinfecting device configured to remove microbial contamination from the permeate fluid.

18. The fluid treatment apparatus of claim 14, further comprising a monitoring means whereby the quality of said permeate fluid is caused to be monitored; and
a controlling means whereby permeate fluid that exceeds a predetermined contaminant level is prevented from entering said storage means.

20. A filtration method, comprising:
filtering raw water through a reverse osmosis filter system into permeate fluid and concentrate fluid;
recirculating the concentrate fluid to the raw water prior to the reverse osmosis filter device; and
purging the reverse osmosis filter system with permeate fluid when the concentrate fluid reaches a predetermined concentrate level.

21. The method of claim 20, comprising storing the permeate fluid in a pressurized tank.

22. The method of claim 20, comprising introducing a cleaning solution into the raw water to clean at least the reverse osmosis filter system and then purging the cleaning solution from at least the reverse osmosis filter system.

23. The method of claim 20, comprising using an anti-microbial UV light to further filter the concentrate fluid.

24. A filtration device, comprising:
a raw water inlet to receive raw water;
a reverse osmosis filtration system configured to filter the raw water into permeate fluid and concentrate fluid;
a recirculation system coupled to the reverse osmosis filtration system to receive the concentrate fluid and mix the same with the raw water prior to the reverse osmosis filtration system;
a delivery system configured to receive the permeate fluid and deliver final product to a product outlet.

25. The device of claim 24, further comprising a cleaning circuit coupled to the reverse osmosis filtration system.

26. The device of claim 24, comprising a purge line coupled between the delivery system and the reverse osmosis filtration system.
